(19) United States
(12) Patent Application Publication
(10) Pub. No.: US 2016/0256942 A1
(43) Pub. Date: Sep. 8, 2016

(54) MACHINING APPARATUS

(71) Applicant: Willy BOKELAAR, Chesapeake, VA (US)

(72) Inventor: Willy BOKELAAR, Chesapeake, VA (US)

(21) Appl. No.: 15/053,718

(22) Filed: Feb. 25, 2016

Related U.S. Application Data
(60) Provisional application No. 62/128,221, filed on Mar. 4, 2015.

(51) Int. Cl. B23D 59/00; B25H 1/00; B23D 47/02

(52) U.S. Cl. CPC B23D 59/007; B23D 47/02; B25H 1/0078; B25H 1/0042

(57) ABSTRACT

A machining apparatus includes a base defining a longitudinal axis, a trolley with a lower section disposed on the base and an upper section disposed on the lower section, an upright assembly removably connected to the base, a cross-cut guide connected to the trolley, and a carriage slidably disposed on the cross-cut guide. The trolley slides along the base parallel to the longitudinal axis. The upper section moves along a transverse axis that is transverse to the longitudinal axis such that the upper section transitions between a retracted position and an extended position, establishing a predetermined distance between the cross-cut guide and the upright assembly when the upper section is in the extended position.

### CROSS-REFERENCE TO RELATED APPLICATION(S)

This International Patent Cooperation Treaty (“PCT”) patent application relies for priority on U.S. Provisional Patent Application Ser. No. 62/128,221, filed on Mar. 4, 2015, entitled “PANEL SAW,” the entire contents of which are incorporated herein by reference.

### FIELD OF THE INVENTION

The present invention concerns a machining apparatus, which is referred to commonly as a panel saw when equipped with a saw as a cutting device. The machining apparatus permits controlled machining and/or cutting of, inter alia, panels and other large-sized construction materials. Among other features, the present invention concerns a machining apparatus that is configurable to a compact state to facilitate transport and storage thereof.

### BACKGROUND OF THE INVENTION

The construction industry has available to it many different devices that assist with the cutting and/or shaping of various materials including oversized materials.

Oversized materials include, but are not limited to plywood and siding panels, both of which tend to be many feet long and several feet wide. Oversized materials also include lumber, structural columns, and other materials that have at least one dimension that is several feet long. Due to the sizes of these materials, they are cumbersome to manipulate and difficult to cut to proper sizes.

Many prior art tools designed to help handle these types of materials are based on a traditional work horse that has been modified to include apparatuses that assist with cutting and/or machining the oversized construction material. These devices maintain the construction material in a horizontal plane.

In addition, these devices incorporate a machining device, such as a saw, into the apparatus and require the user to move the construction material against the cutting tool of the apparatus. In other words, the construction of prior art devices requires that the object to be machined (i.e., the construction material) be manipulated by the user. As should be apparent, manipulating large, bulky objects into a machining tool presents challenges to the user.

Another disadvantage to this traditional approach lies in the complexity of the devices. In order to ensure that the construction materials are machined properly and/or are cut to appropriate dimensions, the prior art devices incorporate complex devices that allow the user to select a particular angle for a particular machining or cutting of the construction material.

A further disadvantage to approach taken in the prior art lies in the weight associated with these traditional devices. Specifically, it has been observed that traditional devices often weigh fifty pounds, seventy pounds, one hundred pounds, or more. While weight is not typically a problem when the apparatus is positioned in a fixed location, weight becomes an issue when the device is required to be moved between plural locations within a particular worksite or between different worksites.

Still further, a disadvantage in devices known in the prior art lies in the lack of transportability of the devices. Often, they are large and cumbersome and, therefore, awkward and/or difficult to move from one location to another.

It has been observed, therefore, that a more portable device for machining and/or cutting construction materials may be of some utility at construction sites.

### SUMMARY OF THE INVENTION

The present invention intended to address one or more of the deficiencies in the prior art.

In general, the present invention provides for a machining apparatus that includes a base defining a longitudinal axis, a trolley with a lower section disposed on the base and an upper section disposed on the lower section, an upright assembly removably connected to the base, a cross-cut guide connected to the trolley, and a carriage slidably disposed on the cross-cut guide. The trolley slides along the base parallel to the longitudinal axis. The upper section moves along a transverse axis that is transverse to the longitudinal axis such that the upper section transitions between a retracted position and an extended position, establishing a predetermined distance between the cross-cut guide and the upright assembly when the upper section is in the extended position.

In one embodiment, it is contemplated that the base includes a first base portion and a second base portion. The first base portion is removably connectable to the second base portion.

In another embodiment, the machining apparatus may include a first upright base attachment slidably disposed on the base and a second upright base attachment slidably disposed on the base. The upright assembly removably attaches to the first and second upright base attachments.

In yet another embodiment, it is contemplated that the base of the machining apparatus includes a first rail and a second rail disposed a predetermined distance from the first rail. The first and second rails are contemplated to extend long the longitudinal axis of the base.

In still another embodiment, the upright assembly may include a first support bracket connectible to the first upright base attachment, a second support bracket connectible to the second upright base attachment, and a plurality of uprights comprising a first upright connected to the first support bracket and a second upright connected to the second support bracket, with any remaining ones of the plurality of uprights being disposed between the first upright and the second upright.

Embodiments of the machining apparatus also may include a ripping guide disposed between the first upright and the second upright.

It is contemplated that the ripping guide will be adjustable along a vertical axis that is orthogonal to the longitudinal and transverse axes.

It is also contemplated that the ripping guide may include a plurality of slots and a plurality of brackets slidably disposed in the plurality of slots.

In one embodiment of the machining apparatus, the trolley slides on the base between the first upright base attachment and the second upright base attachment.

The machining apparatus alternatively may be constructed so that the cross-cut guide includes a first cross-cut portion and a second cross-cut portion removably connected to the first cross-cut portion.

It is also contemplated that the cross-cut guide includes a longitudinal opening extending along a length thereof, a first surface on a first side, and a second surface on a second side.

The carriage for the machining apparatus is contemplated to include a body disposable on the cross-cut guide, wherein the body defines an exposed surface capable of receiving a machining tool, such as a saw, thereon. The carriage also is contemplated to include a plurality of first wheels disposed on the body, wherein the plurality of first wheels engage the first surface of the cross-cut guide and a plurality of second wheels disposed on the body, wherein the plurality of second wheels engage the second surface of the cross-cut guide.

In an additional contemplated embodiment, the machining apparatus may include a force-assist mechanism connected between the carriage and the cross-cut guide to facilitate movement of the carriage on the cross-cut guide.

It is contemplated that the force-assist mechanism may include a frame, a cable reel disposed on the frame, and a cable disposed on the cable reel. If so, the cable is contemplated to include a loose end, with the loose end connecting to the carriage.

It is also contemplated that the cable reel includes a spring that biases movement of the cable reel in one direction of rotation.

In another contemplated embodiment, the machining apparatus may have a height adjustment mechanism connected to the base permitting adjustment of a height of the base from a ground surface.

It is contemplated that the machining apparatus may include an upright support bar on which the plurality of uprights are slidably disposed.

In still another contemplated embodiment, the machining apparatus may include a protractor assembly disposed on the trolley to which the cross-cut guide is attached.

Where a protractor assembly is provided, the cross-cut guide is contemplated to be attached to the protractor assembly so that it is positionable at a predetermined angle with respect to the longitudinal axis.

The machining apparatus also may include a plurality of wheels attached to the base.

Other aspects of the invention will become apparent to those skilled in the art after appreciating the details presented below.

### BRIEF DESCRIPTION OF THE DRAWING(S)

The present invention is described in connection with the drawing appended hereto, in which:

FIG. 1 is perspective, front view of one contemplated embodiment of a machining apparatus according to the present invention, illustrating the machining apparatus in a fully assembled condition;

FIG. 2 is a perspective, front view of the embodiment of the machining apparatus shown in FIG. 1 with the tool (i.e., the saw) and the ripping guide removed;

FIG. 3 is a perspective, rear view of a portion of the back of the protractor assembly on the machining apparatus of the present invention shown in FIG. 1;

FIG. 4 is a perspective, front view of the machining apparatus shown in FIG. 2 with the protractor assembly and cross-cut guide removed;

FIG. 5 is a perspective, front view of the machining apparatus shown in FIG. 4 with the trolley assembly removed;

FIG. 6 is a perspective, rear view of the machining apparatus shown in FIG. 5 with the cross struts removed;

FIG. 7 is a perspective, front view of the machining apparatus shown in FIG. 6 with the uprights collapsed at one end thereof;

FIG. 8 is a perspective, front view of the machining apparatus shown in FIG. 7, illustrating the separation of the stand into a stand extension portion and a miter stand portion;

FIG. 9 is a perspective, front view of the miter stand portion of the machining apparatus shown in FIG. 8, illustrating the removal of attachment pins that permit separation of the upright assembly from the miter stand portion;

FIG. 10 is a perspective, front view of the miter stand portion shown in FIG. 9, showing the removal of the upright assembly from the miter stand portion;

FIG. 11 is a perspective, front view of the miter stand portion illustrated in FIG. 10;

FIG. 12 is a perspective, front view of the miter stand portion shown in FIG. 11, with the upright assembly and the trolley placed thereon to facilitate transport thereof;

FIG. 13 is a perspective, front view of the stand extension portion illustrated in FIG. 8, showing the ripping guide, protractor assembly, and cross-cut guide stacked thereon to facilitate transport thereof;

FIG. 14 is a graphical, side representation of the machining apparatus shown in FIG. 1, illustrating the trolley and cross-cut guide in a first orientation;

FIG. 15 is a graphical, side representation of the machining apparatus shown in FIG. 1, illustrating the trolley and cross-cut guide in a second orientation;

FIG. 16 is a graphical, side representation of the machining apparatus shown in FIG. 15, illustrating one manner of operation transitioning from the second orientation to the first orientation;

FIG. 17 is an end view of a portion of the machining apparatus illustrated in FIG. 1, providing details with respect to the trolley portion thereof;

FIG. 18 is a perspective illustration of the machining apparatus shown in FIG. 1, illustrating one orientation of a piece of construction material thereon;

FIG. 19 is an enlarged detail of one end of the ripping guide shown connected to the upright assembly, as illustrated in FIG. 1;

FIG. 20 is a perspective illustration of one end of the cross-cut guide, showing the manner of installation of the carriage thereon;

FIG. 21 is an end view of the cross-cut guide and carriage illustrated in FIG. 20;

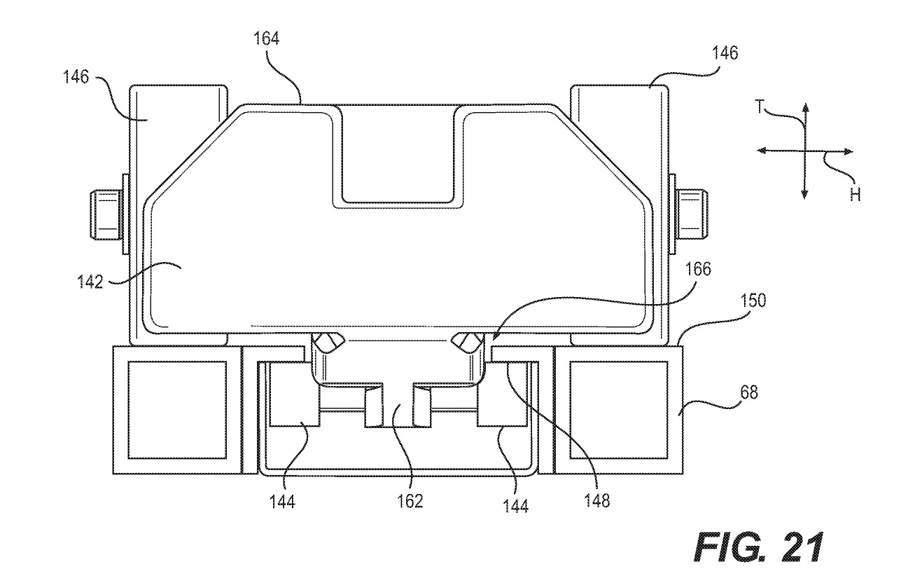

FIG. 22 provides a top view and a side view of one contemplated embodiment of a force assist mechanism, specifically a spring-biased mechanical reel, that may be connected to the distal end of the cross-cut guide and be connected to the carriage to provide force assistance to the movement of the carriage along the length of the cross-cut guide;

FIG. 23 is a perspective, front view of a second embodiment of a machining apparatus according to the present invention, the machining apparatus being illustrated in a deployed condition;

FIG. 24 is an enlarged view of selected elements illustrated in FIG. 23; and

FIG. 25 is an elevational, side view of selected elements of the machining apparatus illustrated in FIG. 23, the selected elements being shown in a collapsed condition.

### DETAILED DESCRIPTION OF EMBODIMENT(S) OF THE INVENTION

The present invention will now be described in connection with one or more embodiments. Discussion of any particular embodiment is intended to be exemplary only. In other words, the embodiments described are intended to outline the breadth of the scope of the present invention. As should be apparent to those skilled in the art, there are numerous equivalents and variations that may be employed without departing from the scope of the present invention. Those equivalents and variations are intended to be encompassed by the present invention. Moreover, elements from one embodiment are contemplated to be employable on other embodiments, as should be apparent to those skilled in the art.

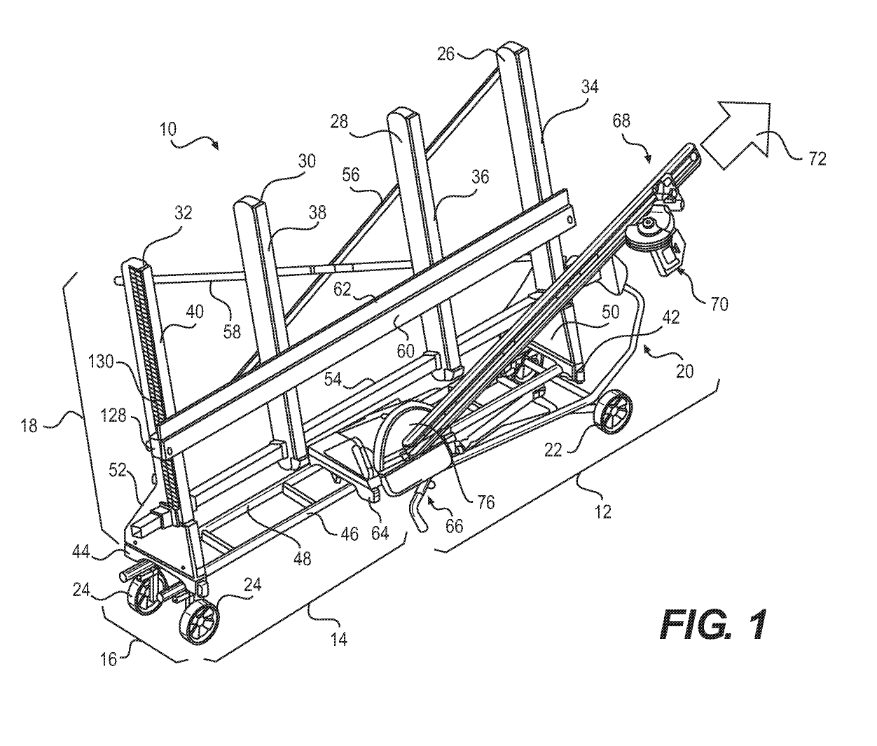

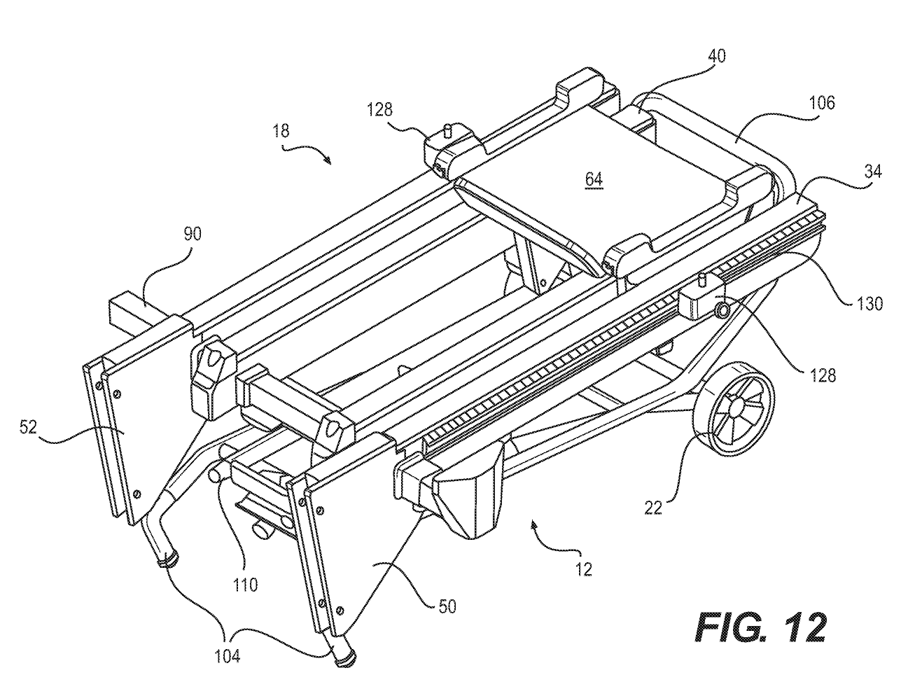

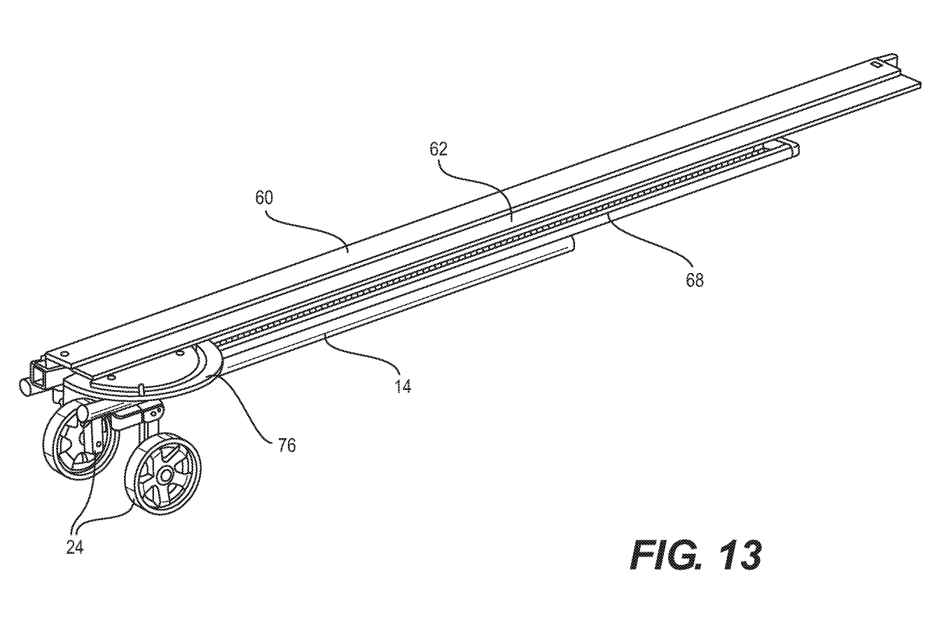

Before delving into the specifics a first embodiment of the machining apparatus 10 of the present invention, it is noted that FIGS. 1-13 generally provide an overview of one contemplated method for altering the configuration of the machining apparatus 10. In particular, FIG. 1 is a perspective, front view of the machining apparatus 10 in a fully deployed condition. As should be apparent to those skilled in the art, the fully deployed condition of the machining apparatus 10 encompasses a state where the machining apparatus 10 is capable of receiving a piece of construction material C. FIGS. 12 and 13, on the other hand, illustrate the machining apparatus 10 after being broken down and prepared for transportation from one physical location to another. As a result, FIGS. 12 and 13 depict what is referred to herein as the non-deployed or collapsed condition. The progression from FIG. 1 to FIG. 13 is contemplated to provide a visual progression of one contemplated way in which the machining apparatus 10 may be transitioned from the deployed condition to the collapsed condition. The illustrations, however, are not contemplated to be limiting of the present invention.

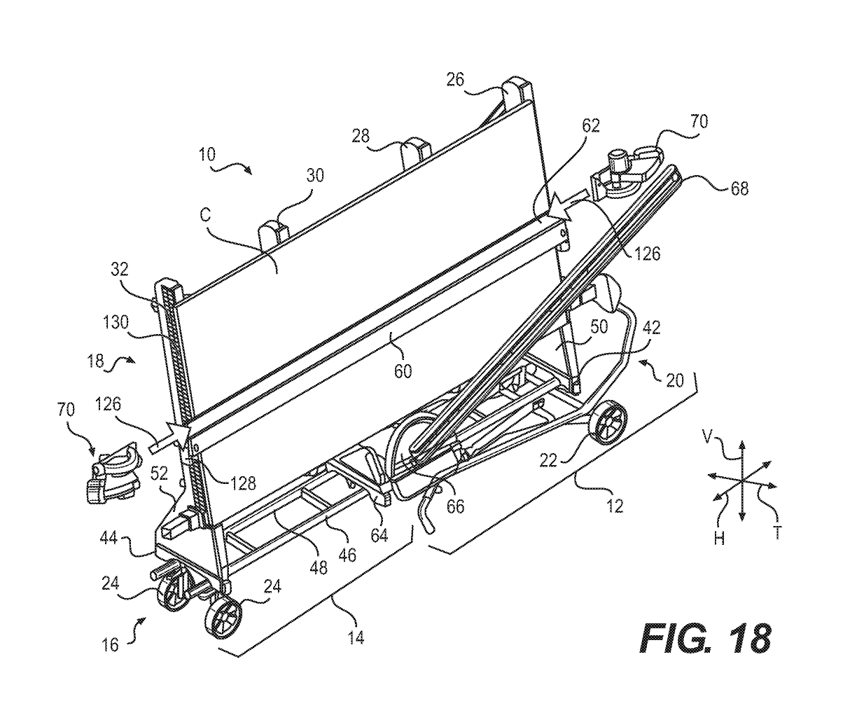

With reference to FIG. 1, the machining apparatus 10 of the present invention is illustrated in the deployed condition. The machining apparatus 10 includes a miter stand portion 12 (also referred to herein as a “first portion”) that is connected to an extension portion 14 (also referred to herein as a “second portion”). Together, the miter stand portion 12 and the extension portion 14 form the base 16 of the machining apparatus 10. An upright assembly 18 is attached to the base 16 and extends upwardly therefrom. As illustrated in FIG. 18, for example, the upright assembly 18 is contemplated to receive one or more construction materials C that are to be machined and/or cut on the machining apparatus 10.

Concerning the construction materials C, it is noted that the machining apparatus 10 of the present invention may be employed to machine and/or cut any type of construction material C. Specifically, the machining apparatus 10 may be employed to machine and/or cut construction materials of any size C and of any composition. While the machining apparatus 10 of the present invention may be employed to machine and/or cut construction materials C of any type, it is contemplated that the machining apparatus 10 will be employed to machine and/or cut oversized construction materials C. Oversized construction materials C include, but are not limited to panels, plywood panels, particle board panels, drywall panels, boards, wood boards, composite boards, beams, wood beams, composite beams, pipes, pipes made from polyvinylchloride (“PVC”), pipes made from metals including copper, etc. Oversized construction materials C are defined herein as materials that have at least one dimension exceeding 3-4 ft. (91.44-121.92 cm). As noted, however, the machining apparatus 10 of the present invention is not limited solely to construction materials C. Items of any size may be machined and/or cut by the machining apparatus 10 of the present invention, as should be apparent to those skilled in the art.

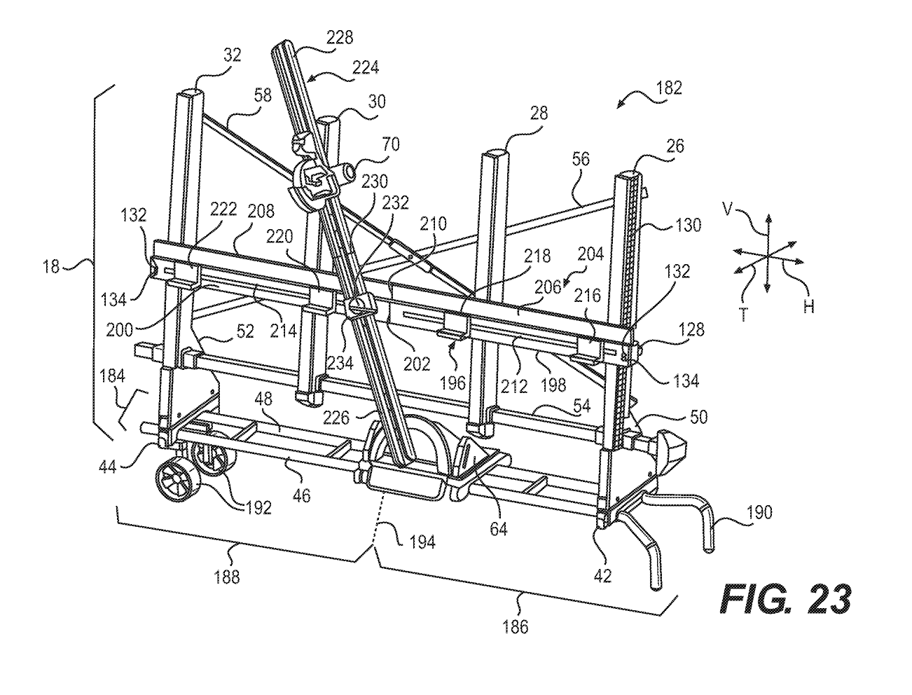

With reference to the miter stand portion 12 of the machining apparatus 10, the use of the term “miter stand” or “miter saw” is not intended to be limiting of the present invention. A miter saw is defined generally as a saw that is designed to create cross-cuts in materials, i.e., miter cuts. While the machining apparatus 10 of the present invention includes a miter stand portion 12, the present invention is not limited to such a construction. Any other stand portion may be substituted for the miter stand portion 12 without departing from the scope of the present invention. Alternatively, as provided in the second embodiment of the machining apparatus 182 of the present invention, which is illustrated in FIGS. 23-25, the miter stand portion 12 may be eliminated from the base 16 without departing from the scope of the present invention.

With continued reference to the machining apparatus 10 illustrated in FIG. 1, it is noted that the machining apparatus 10 is contemplated to be constructed from materials that are light in weight and/or are robust and are durable. In particular, a low weight for the machining apparatus 10 is contemplated to facilitate transportation of the machining apparatus 10 from one location to another when the machining apparatus 10 is in either the deployed or collapsed condition. Materials contemplated for the construction of components of the machining apparatus 10 include, but are not limited to, aluminum, alloys of aluminum, magnesium, alloys of magnesium, beryllium, alloys of beryllium, plastics, thermoplastics, polymers, ceramics, composite materials, carbon fiber composite materials, aramid composite materials, natural materials including, but not limited to wood, iron, alloys of iron, steel, and alloys of steel. It is also contemplated that the machining apparatus 10 may be made from any combination of the materials enumerated in addition to those not listed. It is noted that the machining apparatus 10 is not contemplated to be limited to materials now known. The machining apparatus 10 may be made from materials that are developed at a future date without departing from the scope of the present invention.

For purposes of the discussion that follows, the various components of the machining apparatus 10 are contemplated to be made from aluminum and/or an alloy of aluminum. While aluminum and/or alloys of aluminum are contemplated to be employed to construct the machining apparatus 10 of the present invention, as noted above, any discussion of aluminum and/or its alloys is not intended to be limiting of the present invention.

The miter stand portion 12 of the machining apparatus 10 is contemplated to include a miter stand frame 20 that includes at least one pair of wheels 22 (also referred to as a first pair of wheels 22). The extension portion 14 of the machining apparatus 10 also is contemplated to include at least one pair of wheels 24 (also referred to as a second pair of wheels 24). The first and second pairs of wheels 22, 24 are disposed at opposite ends of the base 16 and support the base 16. In addition, the wheels 22, 24 permit the machining apparatus 10 to be moved when the machining apparatus 10 is configured in the deployed condition or in the collapsed condition. As may be apparent to those skilled in the art, it is contemplated that the wheels 22, 24 may be provided with suitable locks to prevent inadvertent movement of the machining apparatus 10 when in the deployed condition, for example.

The upright assembly 18 includes four uprights 26, 28, 30, 32. While the uprights 26, 28, 30, 32 may be made from any suitable material, the uprights 26, 28, 30, 32 are contemplated to be made from plastics, high density plastics, foam, wood, etc. These materials are not intended to be limiting of the present invention. The uprights 26, 28, 30, 32 are contemplated to be made from materials that are rigid and low in weight. In addition, the materials used for the construction of the uprights 26, 28, 30, 32 should be durable and yet offer flexibility in manufacture. Other aspects associated with the uprights 26, 28, 30, 32 should be apparent to those skilled in the art.

Concerning the uprights 26, 28, 30, 32, it is contemplated that the uprights 26, 28, 30, 32 will be positioned on the base 16 such that the uprights 26, 28, 30, 32 form an angle with respect to the base. As a result of this angled orientation, as further illustrated in FIG. 18, construction materials C placed on the machining apparatus 10 will be held against the uprights 26, 28, 30, 32 at least partially by the weight of the construction material C.

The four uprights 26, 28, 30, 32 each are surfaced with a sacrificial facing 34, 36, 38, 40. The sacrificial facings 34, 36, 38, 40 may be made of any suitable material including, but not limited to, plastics, polyvinylchloride (“PVC”), nylon, wood, particle board, plywood, etc. The sacrificial facings 34, 36, 38, 40 are removably connected to the front surfaces of the uprights 26, 28, 30, 32 and come into contact with the construction material C when placed on the machining apparatus 10. The sacrificial facings 34, 36, 38 40 are contemplated to provide surfaces that engage with and are cut by a tool, such as a saw blade, during machining and/or cutting of the construction material C. The sacrificial facings 34, 36, 38, 40 are replaceable after a predetermined amount of use.

The uprights 26, 28, 30, 32 connect the base 16 via a first upright base attachment 42 and a second upright base attachment 44. The first and second upright base attachments 42, 44 are contemplated to engage the base 16. In particular, the first and second upright base attachments 42, 44 slidingly engage the first and second rails 46, 48 that are part of the miter stand portion 12 and the extension portion 14.

As should be apparent from FIG. 1, the first upright 26 and the fourth upright 32 differ from the second and third uprights 28, 30. Specifically, the first upright 26 includes a first support bracket 50 and the fourth upright 32 includes a second support bracket 52. As shown in FIG. 1, the first support bracket 50 is integrally manufactured to form a part of the first upright 26. Similarly, the second support bracket 52 is integrally manufactured to form a part of the fourth upright 32. While the first support bracket 50 and the second support bracket 52 are illustrated as being integrally formed as parts of the first upright 26 and the fourth upright 32, an integral construction is not required to practice the present invention. In addition, while the first support bracket 50 and the second support bracket 52 generally are shown with trapezoidal shapes, the support brackets 50, 52 may take any suitable shape without departing from the scope of the present invention.

As may be apparent, the first upright 26 and the fourth upright 32 are contemplated to establish the sides of the upright assembly 18. In other words, any other uprights are contemplated to be sandwiched between the first upright 26 and the fourth upright 32. For example, if ten uprights were provided for the machining apparatus 10, the first upright 26 would be at one end of the group of uprights and the tenth upright would be at the other end. To generalize the construction so that any number of uprights may be employed, the first upright 26 is referred to as the “first upright” (corresponding to the first support bracket 50) and the fourth upright 32 is referred to as the “second upright” (corresponding to the second support bracket 52) with any remaining uprights from the plurality of uprights being disposed therebetween. The present invention is not intended to be limited to any number of uprights. Two uprights, however, is considered to be a minimum number for the most simple contemplated embodiment.

With continued reference to FIG. 1, an upright support bar 54 extends from the first upright support bracket 50 to the second upright support bracket 52. The second upright 28 and the third upright 30 are disposed slidingly on the upright support bar 54.

To provide additional stability to the uprights 26, 28, 30, 32, a first cross-bar 56 and a second cross-bar 58 extend diagonally from the first upright 26 to the fourth upright 32. The first and second cross-bars 56, 58 form an “X” at the rear of the upright assembly 18. As may be apparent to those skilled in the art, it is contemplated that the second and third uprights 28, 30 may or may not be attached to the cross-bars 56, 58. In addition, it is contemplated that a larger or a fewer number of cross-bars 56, 58 may be employed without departing from the scope of the present invention. Also, the cross-bars 56, 58 are not required to practice the present invention.

A ripping guide 60 also extends horizontally between the first upright 26 and the fourth upright 32. The ripping guide 60 includes a sacrificial ripping guide attachment 62 that extends along an upper edge thereof. The sacrificial ripping guide attachment 62 is contemplated to be made from the same material(s) as the sacrificial facings 34, 36, 38, 40. The sacrificial ripping guide attachment 62 is provided for the same reasons that the sacrificial facings 34, 36, 38, 40 are provided. Namely, the sacrificial ripping guide attachment 62 may be damaged when the construction material C is machined and/or cut. The sacrificial ripping guide attachment 62 is contemplated to be easily replaced, as needed.

A trolley 64 is disposed on the first and second rails 46, 48 so that the trolley 64 may slide between the first upright 26 and the fourth upright 32. The trolley 64 is removable from the rails 46, 48. It is contemplated that the trolley 64 may include a low friction material on the surfaces that contact the rails 46, 48. Suitable low friction materials include, but are not limited to polytetrafluoroethylene (“PTFE”), oil saturated metals, etc. Alternatively, the trolley 64 may be provided with wheels that contact the rails 46, 48 to facilitate movement of the trolley 64 on the rails 46, 48.

The trolley 64 supports a protractor assembly 66, which connects to a cross-cut guide 68. The cross-cut guide 68 supports a tool 70 thereon. In the illustrated embodiment, the tool 70 is a saw 70. The saw 70 is removable from the cross-cut guide 68 in the direction illustrated by the arrow 72. With respect to the cross-cut guide 68, it is contemplated that the cross-cut guide 68 may be mounted to permit the cross-cut guide 68 to be positioned from 0 to 180° with respect to the base 16. The protractor 76 is contemplated to be provided with indicia (i.e., hash marks) that assist with the angular positioning of the cross-cut guide 68.

In the illustrated embodiments, the tool 70 is contemplated to be a circular saw. However, the present invention is not contemplated to be limited solely to a construction where the tool 70 is a circular saw. To the contrary, the tool 70 may be any other type of machining, cutting, and/or shaping tool. Alternatives include, but are not limited to a band saw, reciprocating saw, knife, router, cutter, compounding saw, drill, laser, etc. It is contemplated that the machining apparatus 10 of the present invention may be adapted to receive any of a number of tools 70 to machine, cut, and/or shape the construction material C, as desired or as required. In other words, the machining apparatus 10 is contemplated to be adaptable to accommodate any number of construction needs and requirements. As may be appreciated by those skilled in the art, other aspects of the machining apparatus 10 may need to be altered to accommodate a tool 70 other than a circular saw. Those modifications are contemplated to be within the level of skill in the art and, accordingly, are not discussed in detail herein.

For clarity, the machining apparatus 10 is illustrated in connection with a saw 70 as the tool 70. The terms “machine,” “cut,” and “shape” are used in connection with the tool 70. It is noted that the terms “machine,” “cut,” and “shape” are used interchangeably herein. Accordingly, reliance on any particular machining term should not be understood to be limiting of the present invention.

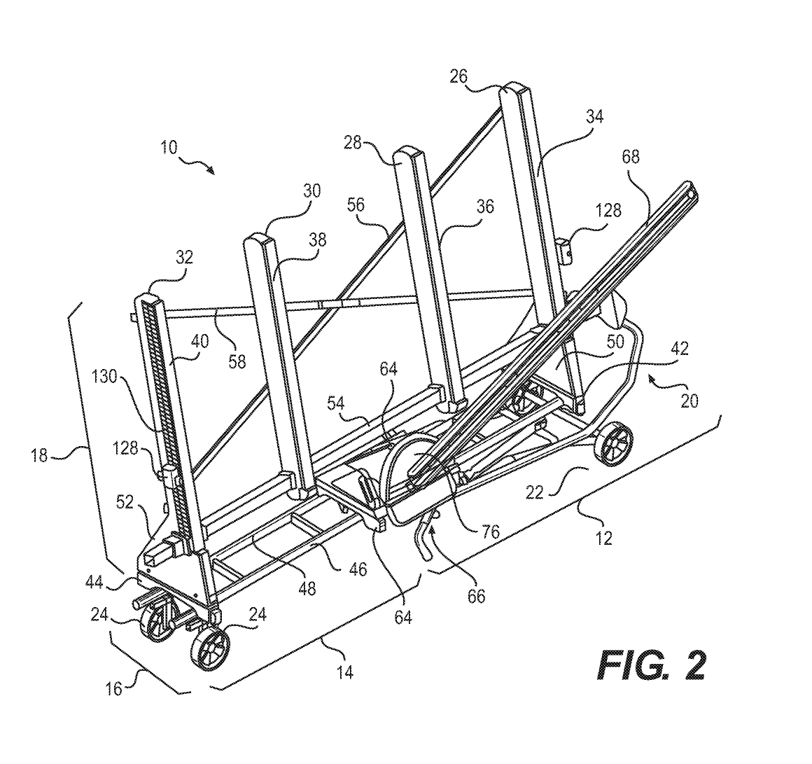

FIG. 2 is a perspective, front view of the machining apparatus 10 illustrated in FIG. 1. In this illustration, the ripping guide 60 and the tool 70 have been removed by comparison with the illustration in FIG. 1. As noted above, this illustrates a first stage in the deconstruction of the machining apparatus 10 in its transition from the deployed condition to the collapsed condition.

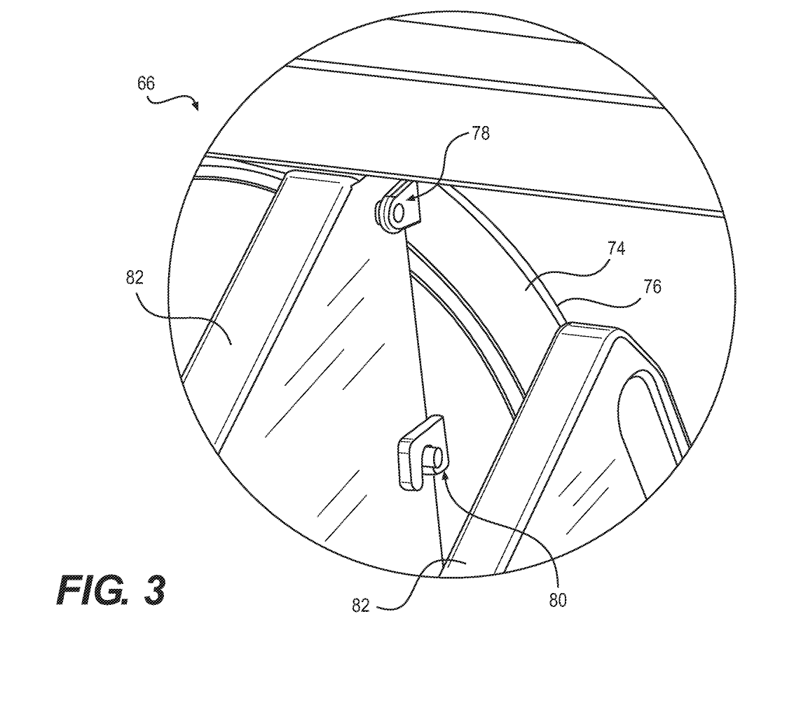

FIG. 3 is a perspective view of a portion of the protractor assembly 66 illustrating one manner contemplated for connecting the protractor assembly 66 to the trolley 64. In particular, it is contemplated that the rear surface 74 of the protractor 76 will be provided with at least two fasteners 78, 80 that engage at least one of the vertical elements 82 on top of the trolley 64. The protractor assembly 66 is contemplated to be removably connected to one or more of the vertical elements 82 on the trolley 64.

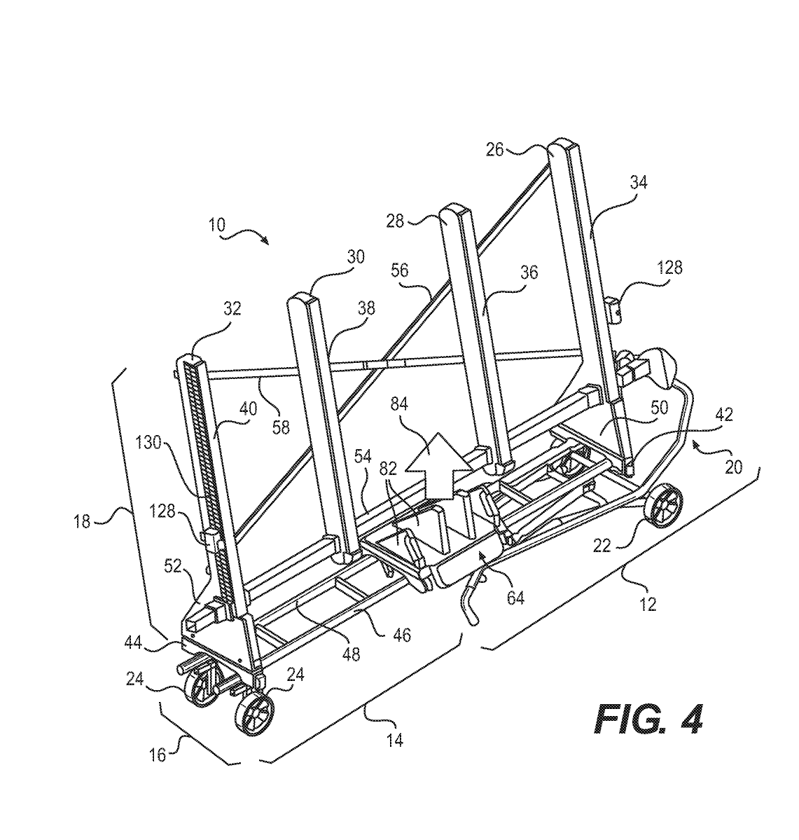

FIG. 4 is a perspective, front view of the machining apparatus 10 illustrated in FIG. 2. In this view, the protractor assembly 66 and the cross-cut guide 68 have been removed by comparison with FIG. 2. FIG. 4, therefore, illustrates a further deconstruction of the machining apparatus 10 in its transition from the deployed condition to the collapsed condition. In this view, the arrow 84 indicates the direction contemplated for removal of the trolley 64 from the rails 46, 48 of the base 16.

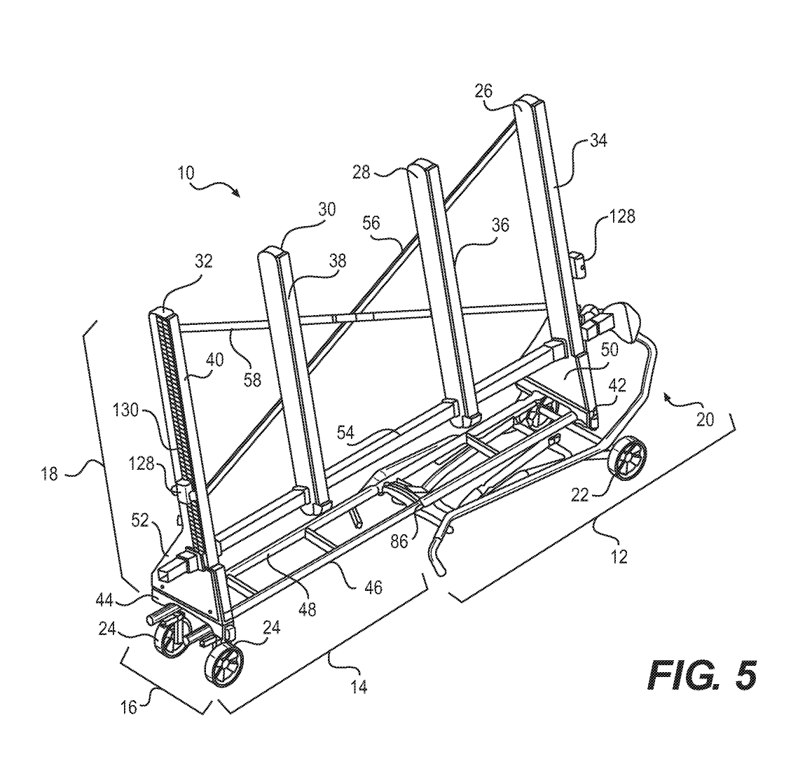

FIG. 5 is a perspective, front view of the machining apparatus 10 illustrated in FIG. 4. In this illustration, the trolley 64 has been removed relative to the illustration provided in FIG. 4. With the trolley 64 removed, the separation line 86 between the miter stand 12 and the extension portion 14 is made visible.

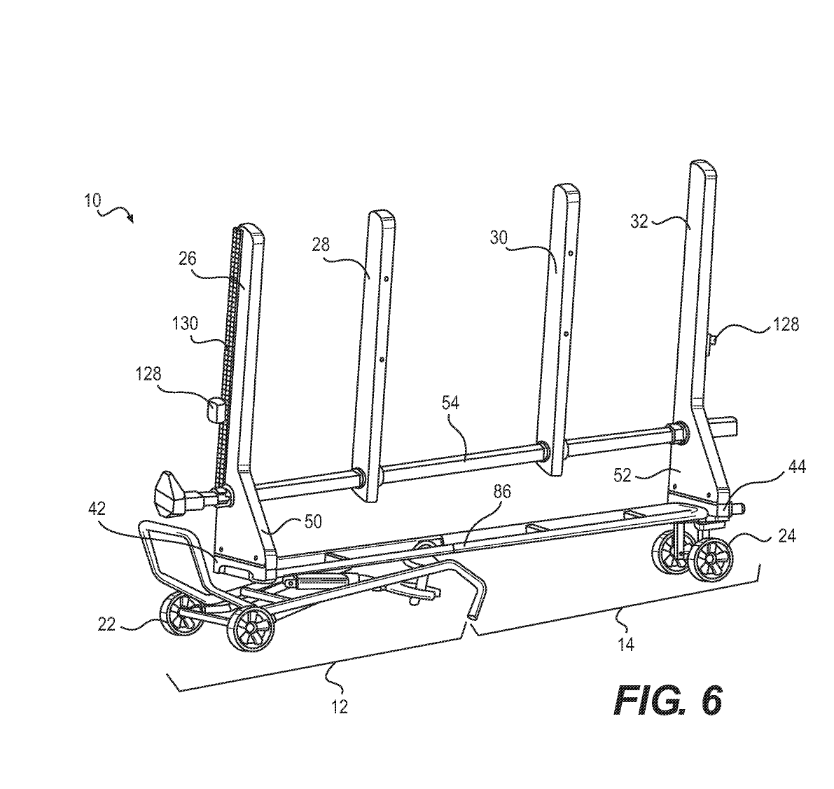

FIG. 6 is a perspective, rear view of the machining apparatus 10 illustrated in FIG. 5. In this illustration, the first cross-bar 56 and the second cross-bar 58 have been removed relative to the state of the machining apparatus 10 illustrated in FIG. 5.

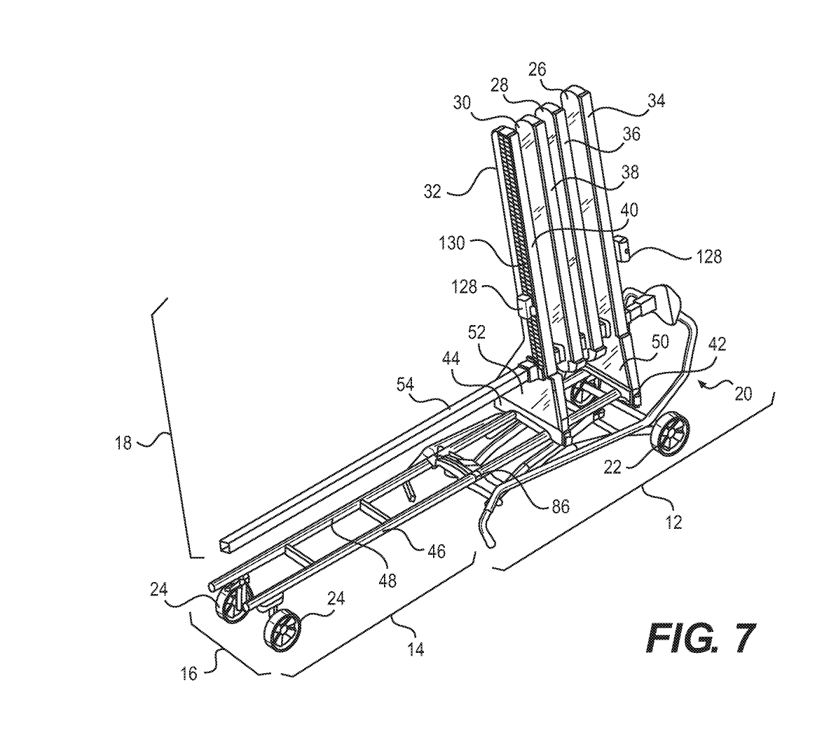

FIG. 7 is a perspective, front view of the machining apparatus 10 illustrated in FIG. 6. In this illustration, by comparison with FIG. 6, the four uprights 26, 28, 30, 32 have been moved along the rails 46, 48 and the upright support bar 54 so that the uprights 26, 28, 30, 32 are positioned on the miter stand portion 12 of the machining apparatus 10. FIG. 7, therefore, presents yet another operation in the process whereby the machining apparatus 10 transitions from the deployed condition to the collapsed condition.

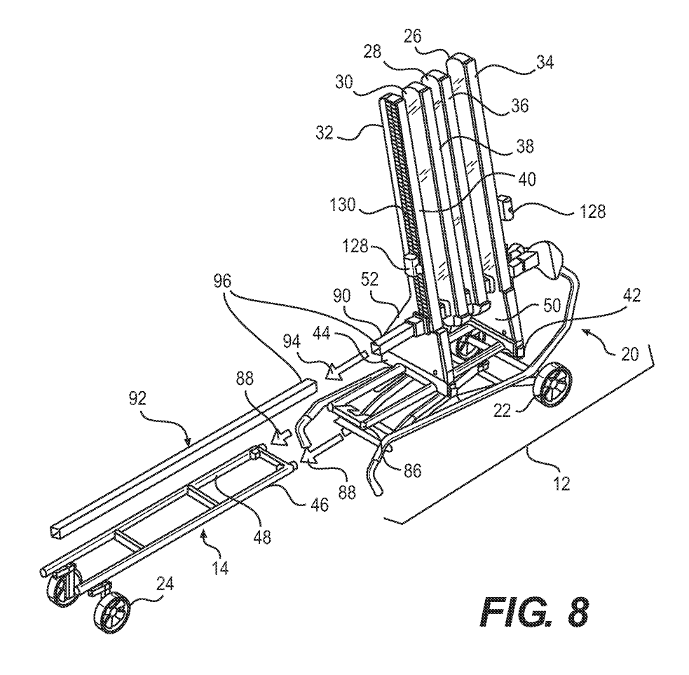

FIG. 8 is a perspective, front view of the machining apparatus 10 illustrated in FIG. 7. In this view, by comparison with FIG. 7, the extension portion 14 is shown after having been separated from the miter stand portion 12. The extension portion 14 is separated from the miter stand portion 12 in the direction of the arrows 88. Similarly, the upright support bar 54 is separated into a first section 90 and a second section 92. The first section 90 is associated with the miter stand portion 12 of the machining apparatus 10. The second section 92 is associated with the extension portion 14 of the machining apparatus 10. The first section 90 and the second section 92 separate, as indicated by the arrow 94, along the separating line 96.

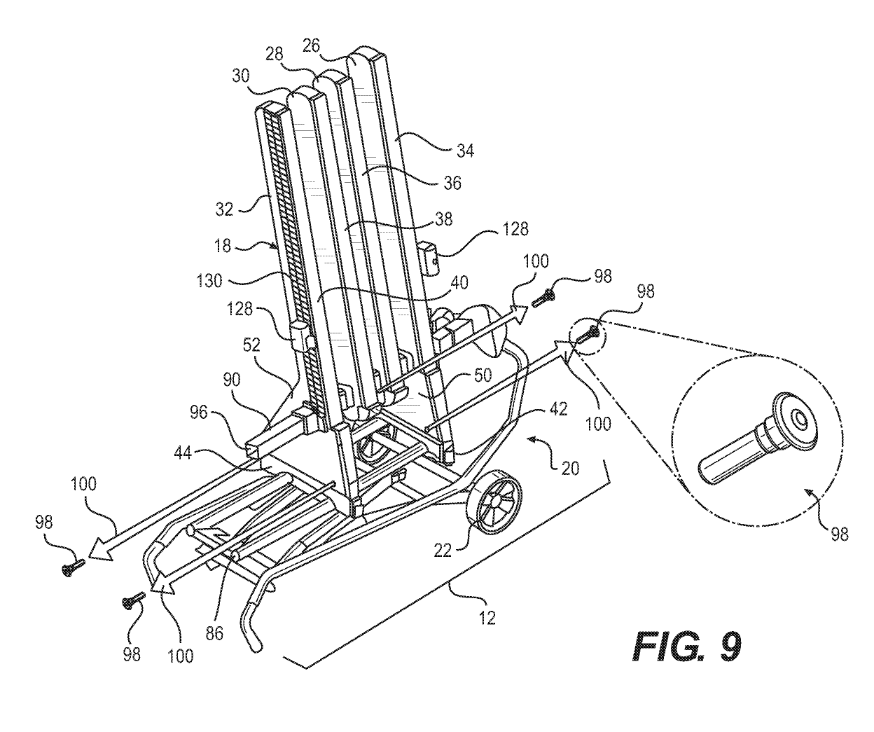

FIG. 9 is a perspective, front view of the miter stand portion 12 and the upright assembly 18 of the machining apparatus 10 illustrated in FIG. 8. In this illustration, by comparison with FIG. 8, the extension portion 14 has been removed. As illustrated in this view, the upright assembly 18, which has been consolidated as discussed above, is contemplated to be removable from the miter stand portion 12. In the illustrated embodiment, which is not intended to be limiting of the present invention, four pins 98 may be removed from the first support bracket 50 and the second support bracket 52. The four pins 98 are removed in the direction of the arrows 100. After removal of the pins 98, the upright assembly 18 may be disengaged from the first upright base attachment 42 and the second upright base attachment 44.

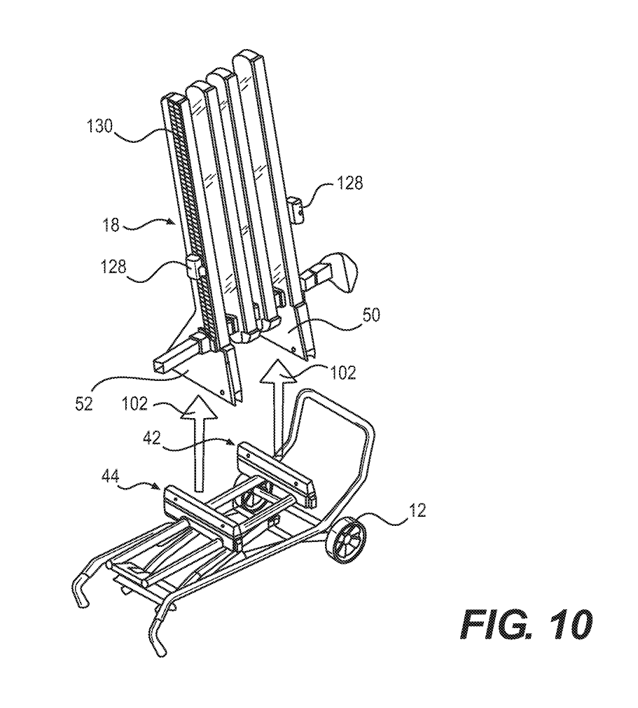

FIG. 10 is a perspective, front view of the miter stand portion 12 and the upright assembly 18 of the machining apparatus 10 illustrated in FIG. 9. In this illustration, by comparison with FIG. 9, the upright assembly 18 is shown after having been separated, along the direction of the arrows 102, from the miter stand portion 12. The first upright base attachment 42 and the second upright base attachment 44 remain disposed on the miter stand portion 12 in this contemplated embodiment. In other contemplated embodiments, however, the first and second upright base attachments 42, 44 also may be removed from the miter stand portion 12 together with the upright assembly 18.

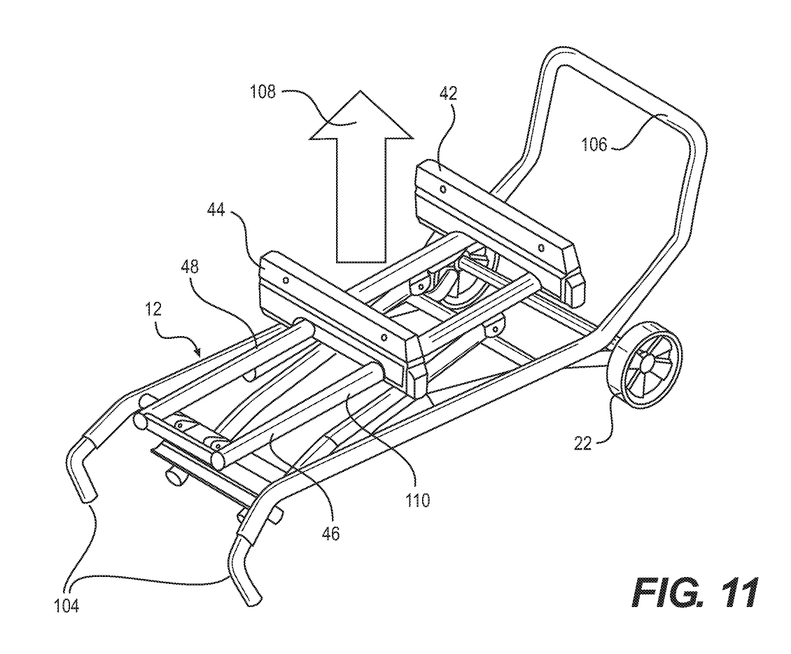

FIG. 11 is a perspective, front view of the miter stand portion 12 of the machining apparatus 10. The miter stand portion 12 is contemplated to include handles 104 at a top end. A footing 106 is provided at the bottom end of the miter stand portion 12. The footing 106 permits the miter stand portion 12 to stand vertically. The handles 104 facilitate transportation of the miter stand portion 12 from one location to another when orientated in an upright position. The handles 104 and the footing 106 optionally may be omitted without departing from the present invention.

The miter stand portion 12 includes an expandable section 110 that expands in the direction of the arrow 108. The expandable section 110 is contemplated to expand, like a scissor jack. The expandable section 110, when expanded, may be used as a standard miter stand by elevating the first and second rails 46, 48. The expandable section 110, therefore, provides an elevated work area, as required or as desired. The expandable section 110 is not required to practice the present invention, as highlighted by the second embodiment of the machining apparatus 182 illustrated in FIGS. 23-25.

FIG. 12 is a perspective, front view of the miter stand portion 12 of the machining apparatus 10, showing the stacking of the upright assembly 18 and the trolley 64 thereon. It is contemplated that this configuration will be employed during transportation of the machining apparatus 10 from one location to another. As should be apparent, this collapsed condition of at least a portion of the machining apparatus 10 is compact by comparison with the deployed condition illustrated in FIG. 1, thereby facilitating transportation of the machining apparatus 10.

FIG. 13 is a perspective, front view of the extension portion 14 of the machining apparatus 10. In this view, the protractor assembly 66 and the ripping guide 60 have been stacked onto the extension portion 14. This illustration shows the remaining elements of the machining apparatus 10 in the collapsed condition. Again, this compact arrangement facilitates transportation of the machining apparatus 10.

It is noted that FIGS. 12 and 13 are intended to illustrate one contemplated collapsed condition for the machining apparatus 10 of the present invention. The illustrations, however, are not intended to be limiting of the present invention.

Throughout the drawings, several relevant axes are depicted. With reference to the machining apparatus 182 provided in FIG. 23, a horizontal axis H, a vertical axis V, and a transverse axis T are indicated. The horizontal axis H is illustrated as being parallel to a longitudinal axis of the base 184. Accordingly, the terms “longitudinal axis” and the “horizontal axis H” are used interchangeably herein. The vertical axis V is contemplated to be perpendicular to a ground surface on which the machining apparatus 182 is positioned. The transverse axis T is contemplated to be perpendicular to and coplanar with the horizontal axis H. In view of the foregoing and consistent with the drawings, the horizontal axis H is orthogonal to the transverse axis T and the vertical axis V is orthogonal to both the horizontal axis H and the transverse axis T.

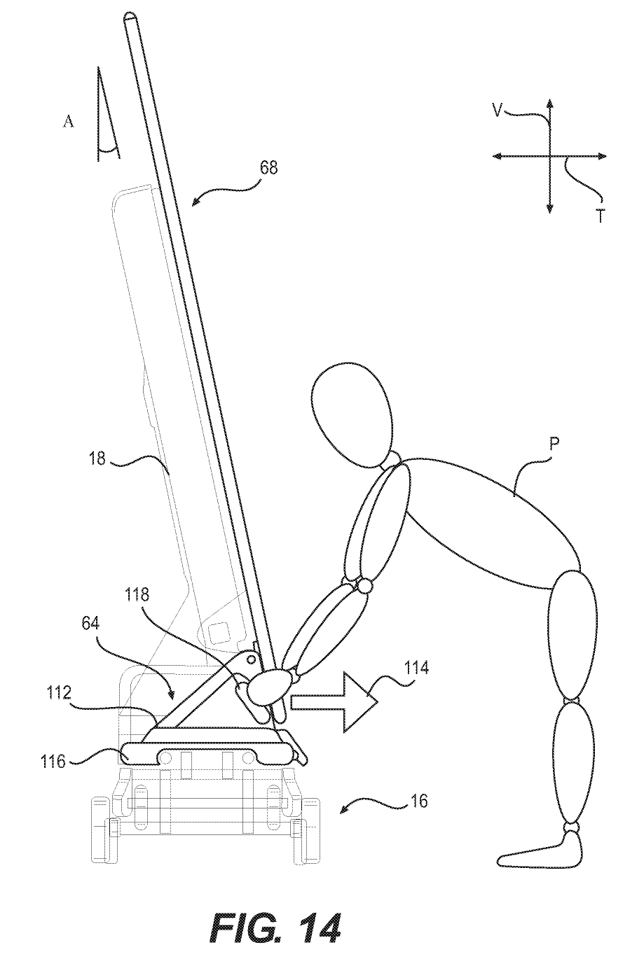

FIG. 14 is a graphical, side view of the machining apparatus 10 illustrated in FIG. 1, shown in the deployed condition. As is apparent from this illustration, the trolley 64 includes an upper section 112 and a lower section 116. To facilitate insertion of the construction material C between the cross-cut guide 68 and the uprights 26, 28, 30, 32, the upper section 112 slides outwardly, in the direction of the arrow 114 (parallel to the transverse axis T), relative to the lower section 116. As noted above, the lower section 116 slidably attaches to the rails 46, 48 so that the lower section moves parallel to the horizontal axis H.

It is contemplated that the upper section 116 is connected to the lower section 112 via rails or other suitable attachment means that permit the upper section 116 to move relative to the lower section 112. The present invention is not contemplated to be limited to any particular arrangement. Those skilled in the art are understood to be capable of employing any suitable attachment means, components, and/or elements to facilitate the operation(s) described herein between the lower section 112 and the upper section 116.

As shown in FIG. 14, the upper section 112 of the trolley 64 includes hand grip elements 118 so that a person P may easily grasp onto the upper section 112 of the trolley 64 to pull the upper section 112 in the direction of the arrow 114 (along the transverse axis T). In the configuration depicted in FIG. 14, the upper section 112 is shown in a retracted position (or first position) such that the cross-cut guide 68 is immediately adjacent to the uprights 26, 28, 30, 32 of the upright assembly 18.

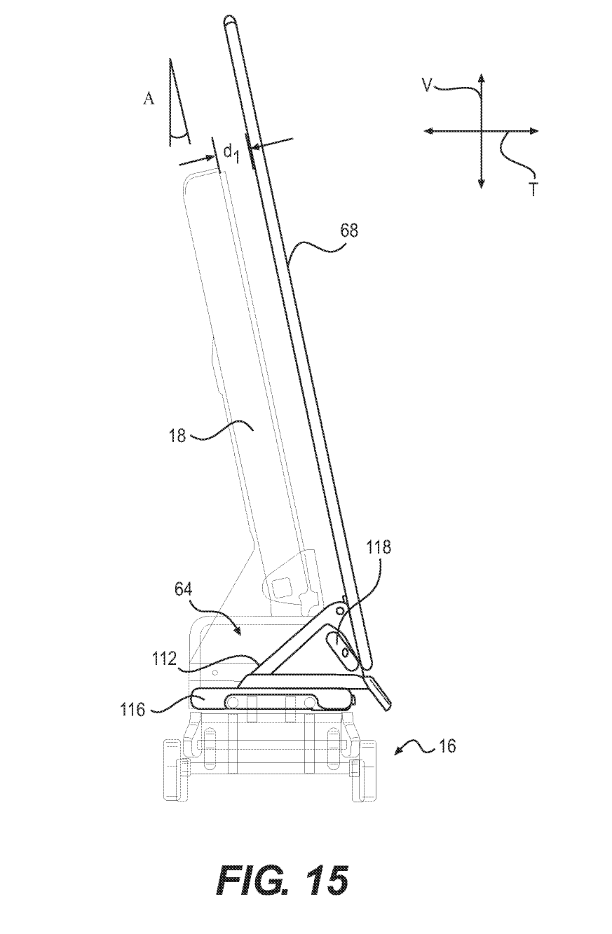

FIG. 15 is a graphical, side view of the machining apparatus 10 illustrated in FIG. 14. In this view, the upper section 112 of the trolley 64 is shown in the extended position (or second position). As noted, the extended position of the upper section 112 of the trolley 64 facilitates insertion of a piece of construction material C on the machining apparatus 10. In this view, the cross-cut guide 68 is separated a distance d₁ from the uprights 26, 28, 30, 32 of the upright assembly 18. The distance d₁ may be any suitable magnitude as required or as desired. While the distance d₁ is illustrated as being uniform between the cross-cut guide 68 and the uprights 26, 28, 30, 32 forming upright assembly 18, it is contemplated that the cross-cut guide 68 may be displaced at an angle to the upright assembly 18 such that the distance d₁ varies from the top to the bottom of the upright assembly 18. It is contemplated that, by maintaining a uniform distance d₁ between the cross-cut guide 68 and the upright assembly 18, the tool 70 will create a more uniform machining and/or cut of the construction material C.

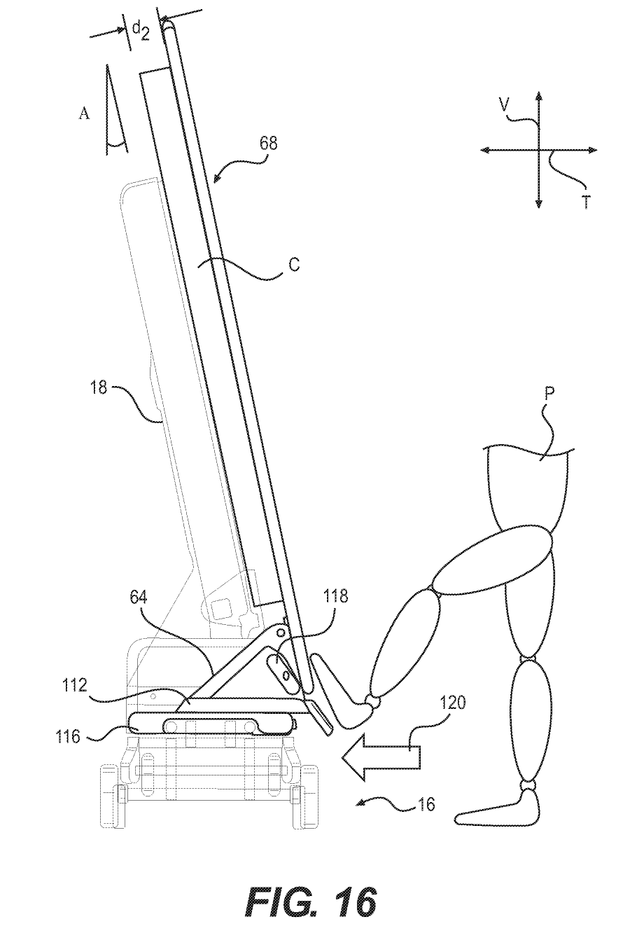

FIG. 16 is a graphical, side view of the machining apparatus 10 illustrated in FIG. 15. In this view, the upper section 112 of the trolley 64 is in an intermediate position (third position). The upper section 112 of the trolley 64 has been pushed into the intermediate position (third position), in the direction of the arrow 120, by the foot of a person P, as illustrated. As such, the cross-cut guide 68 abuts against the construction material C. When the upper section 112 of the trolley 64 is in the intermediate position (third position), the second distance d₂ between the cross-cut guide 68 and the upright assembly 18 is contemplated to be less than the first distance d₁.

For each of the embodiments of the machining apparatus 10, 182, it is contemplated that the trolley 64 will travel on the rails 46, 48 along the longitudinal axis of the base 16, 184. In other words, it is contemplated that the trolley 64 will travel along the horizontal axis H. As noted, the upper section 112 of the trolley 64 is contemplated to move along the transverse axis T. It is noted that the travel of the trolley 64 and the movement of the upper section 112 need not be precisely orthogonal to one another. It may be sufficient for the trolley to move substantially among the horizontal axis H and for the upper section 112 to slide substantially along the transverse axis T without departing from the scope of the present invention.

In FIG. 14, the uprights 26, 28, 30, 32 are illustrated as being disposed at angle A. The angle A is measured in relation to a vertical axis V, as illustrated. As noted, it is contemplated that the angle A will be sufficient to permit the weight of the construction material C to hold the construction material C against the uprights 26, 28, 30, 32.

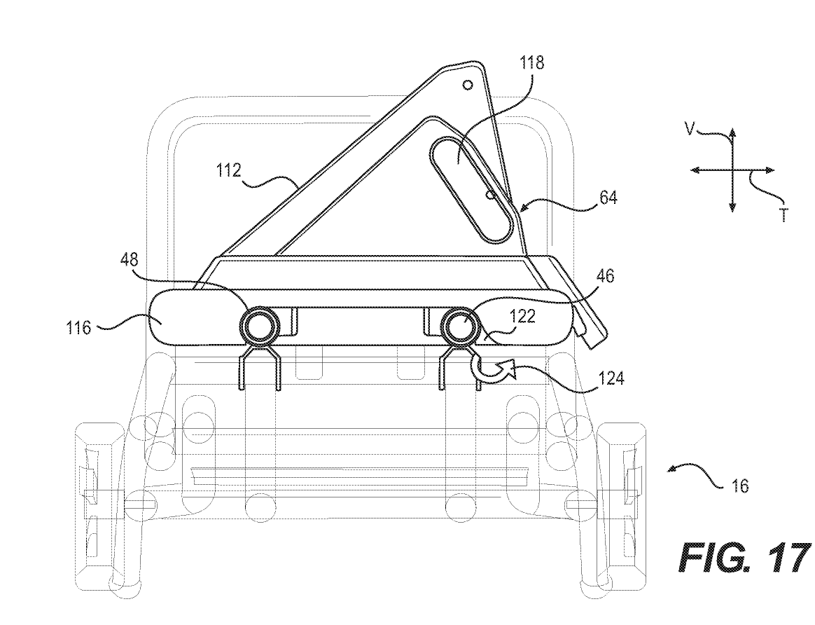

FIG. 17 is a graphical, end view of the base 16 of the machining apparatus 10. This illustration provides additional details with respect to the trolley 64 on the first and second rails 46, 48. In particular, it is contemplated that the lower section 116 of the trolley 64 may include a movable lip 122 that permits the trolley 64 to removably engage the rails 46, 48. The moveable lip 122 is contemplated to be movable, in the direction of the arrow 124, so that the trolley 64 may be released from the first rail 46 and, thereby, also the second rail 48. The inclusion of the moveable lip 122 is not intended to limit the present invention. As should be apparent to those skilled in the art, there are numerous ways in which the trolley 64 may be removably secured to the rails 46, 48 without departing from the scope of the present invention.

FIG. 18 is a perspective, front view of the machining apparatus 10 illustrated in FIG. 1. This view of the machining apparatus 10 is provided to illustrate one contemplated orientation for a piece of construction material C placed thereon. As also indicated in this view, the tool 70 may engage the construction material C along the edge established by the sacrificial ripping guide attachment 62. In the illustrated embodiment, the tool 70 is a saw 70 that is contemplated to cut the construction material C in the direction of the arrows 126.

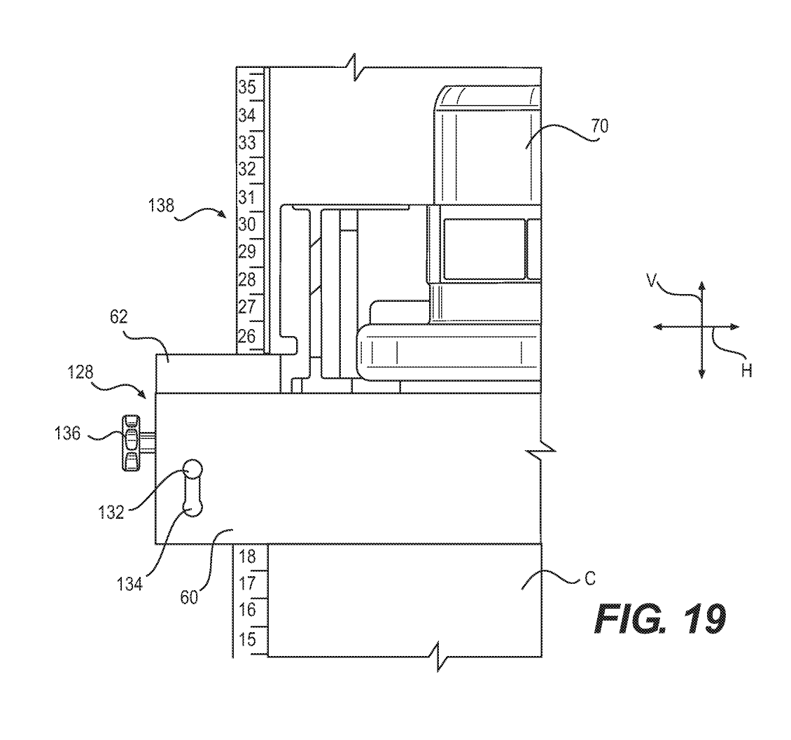

FIG. 19 is an enlarged detail of a portion of the machining apparatus 10. In particular, the enlarged detail encompasses the portion of the machining apparatus 10 where the ripping guide 60 connects to the fourth upright 32. At this connection point, the upright includes a connector 128 that engages a rail 130 (shown, for example, in FIG. 18) in the fourth upright 32. A similar connector 128 is provided on the upright 26. The connectors 128 provide movable connection points between the ripping guide 60 and the upright assembly 18 of the machining apparatus 10.

Pins 132 extend from the connectors 128 through keyholes 134 in the ripping guide 60. The keyholes 134 permits the ripping guide 60 to be removably connected to the connectors 128. A knob 136 may be provided to secure the connector 128 to a particular location on the rail 130. A ruler 138 (or other similar indicia) may be provided to position the ripping guide 60 at a predetermined location on either side of the upright assembly 18.

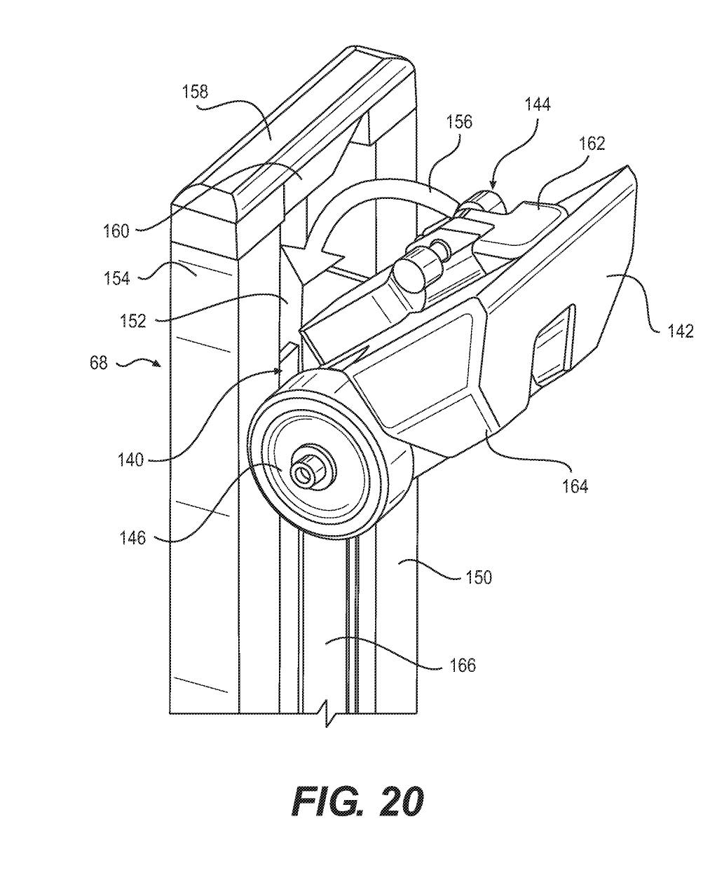

FIG. 20 is an enlarged, perspective view of the distal end of the cross-cut guide 68. This view illustrates the removable placement of a carriage 140 within the cross-cut guide 68.

The carriage 140 includes a body 142. The body has two inner wheels 144 and two outer wheels 146 attached thereto. The inner wheels 144 are contemplated to engage the inner surface 148 of the cross-cut guide 68. The outer wheels 146 are contemplated to engage the outer surface 150 of the cross-cut guide 68.

So that the carriage 140 properly engages the cross-cut guide 68, an opening 152 is provided at the distal end 154 of the cross-cut guide 68. The inner wheels 144 pass through the opening 152 to engage the inner surface 148 of the cross-cut guide 68. As indicated in FIG. 20, the carriage 140 it tilted, in the direction of the arrow 156 until the inner wheels 144 pass through the opening 152 at which time the inner wheels 144 are in proper alignment to engage the inner surface 148 of the cross-cut guide 68.

As also illustrated in FIG. 20, the cross-cut guide 68 is capped at the distal end 154 with an end cap 158. In the illustrated embodiment, the end cap 158 includes a recess 160 that facilitates placement of the carriage 140 onto the cross-cut guide 68.

With respect to the carriage 140, it is noted that the body 142 includes a protrusion 162 onto which the inner wheels 144 are mounted. The tool 70 is removably mountable to the exposed surface 164 of the carriage 140. A longitudinal opening 166, that extends along the cross-cut guide 68 accommodates the travel of the carriage 140 on the cross-cut guide 68.

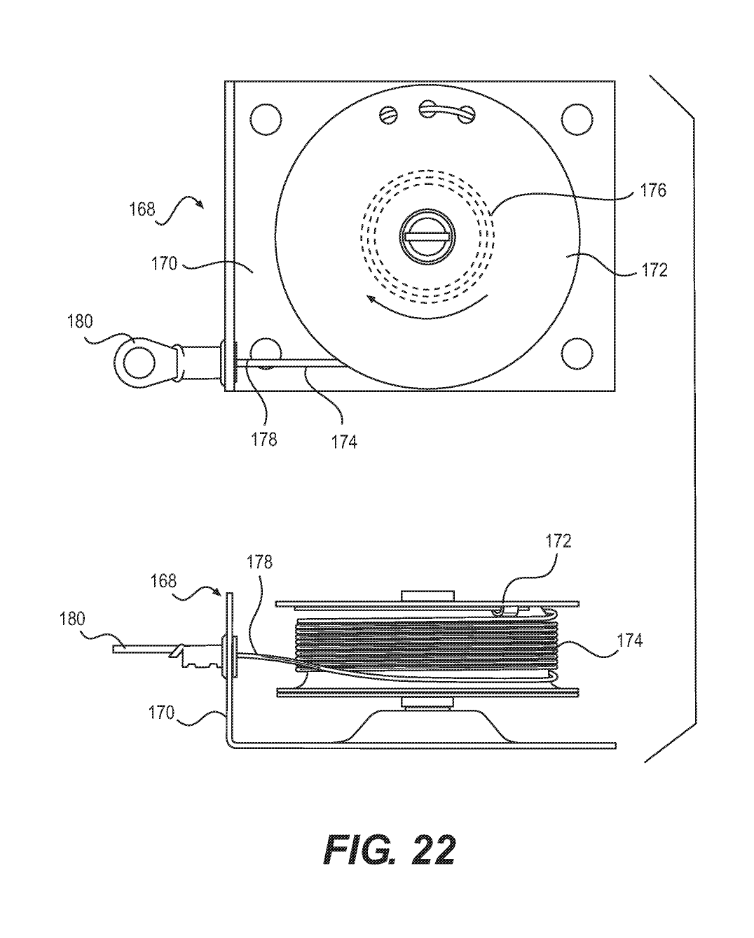

Reference is now made to FIG. 22, which illustrates a contemplated addition to the machining apparatus 10 of the present invention. FIG. 22 provides a top view and a side view of a spring-biased mechanical reel 168 that may be attached to the distal end 154 of the cross-cut guide 68. The spring-biased mechanical reel 168 may be of the type available from Vulcan Springs, a company with a business address at 501 Schoolhouse Road Telford, Pa. 18969, USA.

As illustrated in FIG. 22, the spring-biased mechanical reel 168 includes a frame 170 that supports a cable reel 172 onto which a cable 174 may be wound. The cable reel 172 houses a spring 176, which is illustrated in dotted lines, because it is contemplated to be housed within the interior of the cable reel 172. The loose end 178 of the cable 174 includes an eyelet 180.

It is contemplated that the eyelet 180 may be connected to the carriage 140. In this manner, the spring-biased mechanical reel 168 is contemplated to contribute at least some force to the carriage 140 to assist with movement of the carriage 140 along the cross-cut guide 68. It is contemplated that the spring-biased mechanical reel 168 will assist the movement of the carriage 140 by at least partially compensating for the weight of the carriage 140 and the tool 70.

As may be appreciated, the spring-biased mechanical reel 168 is merely one contemplated embodiment of a force-assist mechanism that may be added to the cross-cut guide 68 of the machining apparatus 10. Other force assist mechanisms may be employed without departing from the scope of the present invention. For example, a force-assist mechanism may be incorporated within the carriage 140 and be constructed to interact with the structural component of the cross-cut guide 68. The force-assist mechanism might include a battery operated motor disposed in the carriage 140, for example. In other words, while the spring-biased mechanical reel 168 is illustrated and discussed, the machining apparatus 10 of the present invention is not contemplated to be limited to the construction of any particular type of force-assist mechanism.

In a further contemplated embodiment, a force-assist mechanism may be excluded altogether.

It is also contemplated that the machining apparatus 10 of the present invention may be constructed to include one or more mechanisms to permit the user to adjust the height of the machining apparatus 10. Height adjustment may be possible by incorporating one or more scissor jack elements onto the machining apparatus 10, as required or as desired. The height adjustment mechanism is contemplated to permit the user to raise and lower the base 16 to a desired height. With a height adjustment mechanism, it is contemplated that the machining apparatus 10 may find a wider variety of uses, especially for the cutting of stock construction materials C including, but not limited to, 2×4 beams. As should be apparent from the foregoing, large-sized construction materials C may be more easily cut when the machining apparatus 10 is in the deployed condition illustrated in FIG. 1, for example. In this alternative variation, the base 16 may be raised by a height adjustment mechanism to facilitate stock construction materials C.

In another contemplated variation of the machining apparatus 10 of the present invention, it is contemplated that the cross-cut guide 68 may be constructed to permit the length of the cross-cut guide 68 to be adjusted, as required or as desired by the user. For example, the cross-cut guide 68 may be constructed from a number of segments that are connected together to form the entire length of the cross-cut guide 68. In this manner, the user may alter the length of the cross-cut guide, as needed or as desired. The lengths of the different pieces that make up the cross-cut guide 68, in this contemplated embodiment, may be of equal or unequal lengths, as required or as desired.

FIGS. 23-26 illustrate a second embodiment of a machining apparatus 182 according to the present invention. The machining apparatus 182 differs from the machining apparatus 10 in a number of ways, as detailed in the paragraphs that follow.

For purposes of the discussion that follows, the materials discussed in connection with the machining apparatus 10 are contemplated to be the same materials contemplated for construction of the machining apparatus 182. Like reference numbers are employed to refer to like elements described in connection with the machining apparatus 10.

FIG. 23 is a perspective, front view illustration of the machining apparatus 182 according to the present invention. The machining apparatus 182 includes a base 184 that differs from the base 16 of the machining apparatus 10. In this embodiment, the base 184 includes a first portion 186 and a second portion 188. The first portion 186 includes handles 190. The second portion 186 includes a pair of wheels 192.

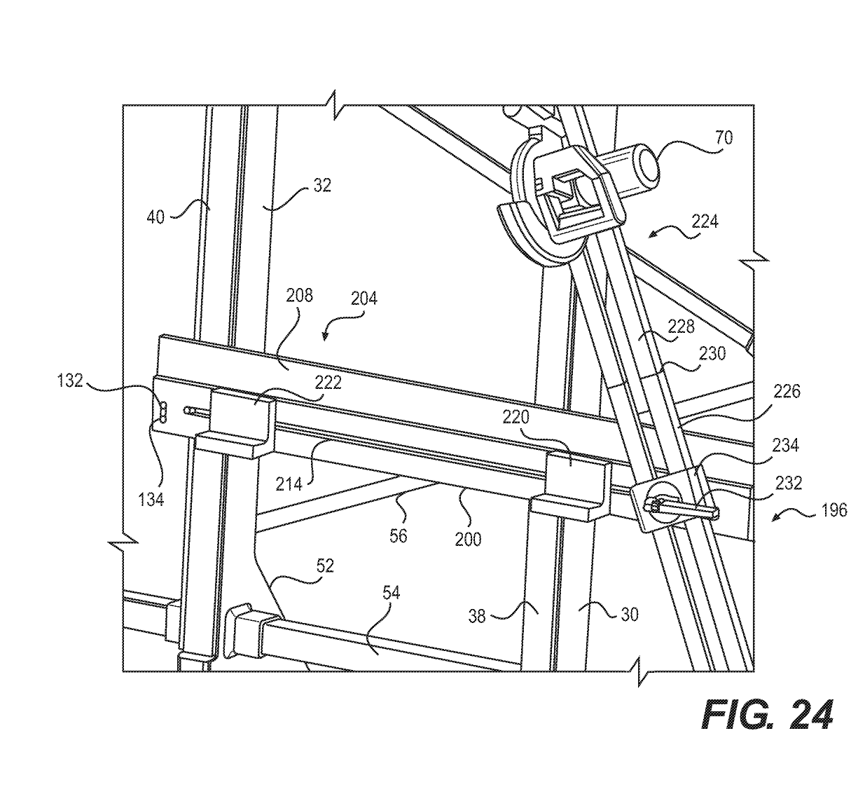

Similar to the construction of the machining apparatus 10, the first portion 186 is separable from the second portion 188 so that the machining apparatus 182 may be transitioned from a deployed condition (as illustrated in FIG. 23) to a collapsed or non-deployed condition (as illustrated in part in FIG. 24). The first portion 186 is separable from the second portion 188 along a seam that is obscured by the trolley 64. The seam is consistent with the dotted line 194 that indicates the separation of the first portion 186 from the second portion 188 in FIG. 23.

As should be apparent from FIG. 23, the first portion 186 of the base 184 is contemplated to be comparable to the miter stand portion 12 of the base 16 for the machining apparatus 10. However, in this embodiment, the first portion 186 of the base 184 excludes the expandable section 110 that is provided on the machining apparatus 10.

In addition, the handles 190 are disposed at the end of the first section 186 rather than being disposed at an intermediate position as illustrated in connection with the machining apparatus 10. In this embodiment of the machining apparatus 182, the handles 190 operate as legs that support the machining apparatus 182.

As also illustrated in FIG. 23, the machining apparatus 182 includes only one pair of wheels 192 rather than the two pairs of wheels 22, 24. The pair of wheels 192 is disposed at the end of the second portion 188.

The second portion 188 of the machining apparatus 182 is contemplated to be similar to the extension portion 14 described in connection with the machining apparatus 10. As should be apparent, the second portion 188 shares the same construction (or nearly the same construction) as the extension portion 14 discussed in connection with the machining apparatus 10.

The machining apparatus 182 is contemplated to include fewer components than the machining apparatus 10. At least for this reason, therefore, the machining apparatus 182 is contemplated to provide a simpler construction that the machining apparatus 10. In addition, with fewer components, the machining apparatus 182 is contemplated to be lighter in weight than the machining apparatus 10.

The machining apparatus 182 differs further from the machining apparatus 10 in that the ripping guide 196 has been modified to accommodate stock construction materials, such as 2×4's (two-by-fours). As a result, although the machining apparatus 182 does not include the expandable section 110, the machining apparatus 182 provides means for machining and/or cutting stock construction materials including, but not limited to 2×4's.

The ripping guide 196 includes a first portion 198 and a second portion 200. The first portion 198 and the second portion 200 are separable from one another along a seam 202. As provided for the machining apparatus 10, the ripping guide 196 includes a sacrificial ripping guide attachment 204. In this embodiment of the machining apparatus 182, the sacrificial ripping guide attachment 204 has a first portion 206 and a second portion 208 that are separable from one another along the seam 210. The seams 202, 210 are contemplated to be co-linear, but such an arrangement is not required to practice the present invention.

The ripping guide 196 includes a first slot 212 and a second slot 214. The first slot 212 is defined by (or disposed in) the first portion 198. The second slot 214 is defined by (or disposed in) the second portion 200. The slots 212, 214 are provided with first, second, third, and fourth brackets 216, 218, 220, 222. Specifically, the first slot 212 includes the first and second brackets 216, 218 and the second slot 214 includes the third and fourth brackets 220, 222. The four brackets 216, 218, 220, 222 are slidably disposed within the slots 212, 214 so that the brackets 216, 218, 220, 222 may be positioned at any suitable location therealong.

The brackets 216, 218, 220, 222 are contemplated to be L-shaped, as illustrated in FIG. 23. While this construction is contemplated to be employed for the machining apparatus 182, an L-shaped construction is not required to practice the present invention. Any other suitable shape for the brackets 216, 218, 220, 222, including but not limited to a J-shape, also is contemplated to fall within the scope of the present invention.

The cross-cut guide 224, which connects to the trolley 64 in the same (or similar) manner as discussed in connection with the machining apparatus 10, is contemplated to be separable into a first portion 226 and a second portion 228. The two portions 226, 228 join together at a seam 230. The seam 230 is contemplated to be located at approximately a center point of the cross-cut guide 224. As in the embodiment of the machining apparatus 10, the tool 70 is slidingly connected to the cross-cut guide 224.

As also illustrated in FIG. 23, the cross-cut guide 224 includes a handle 232 that is slidingly connected thereto. A person P may grasp the handle 232 and hold the cross-cut guide 224 in a predetermined position with respect to any construction material C placed onto the machining apparatus 182. The handle 232 is contemplated to be rotatably disposed on a plate 234 so that the handle 232 may rotate with respect to the orientation of the cross-cut guide 224. The handle 232 is contemplated to rest at the bottom of the cross-cut guide 224 when not in use.

The handle 232 is contemplated to be particularly helpful to a person when cutting a stock construction material, such as a 2×4. Among other things, the handle 232 is contemplated to permit a person P to compensate for the weight of the tool 70 when cutting a construction material C that is disposed on the brackets 216, 218, 220, 222. The handle 232, of course, may be helpful to a person P regardless of the construction material C being cut on the machining apparatus 182.

FIG. 24 is an enlarged, perspective view of a portion of the machining apparatus 182 illustrated in FIG. 23. Selected details associated with the cross-cut guide 224, the brackets 220, 222, and the handle 232 are provided.

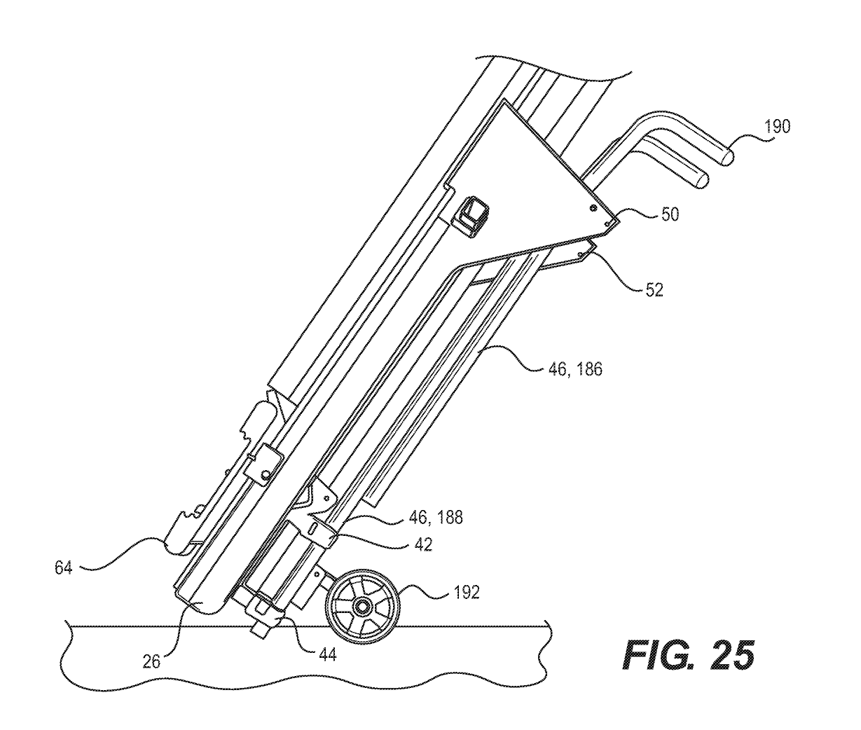

FIG. 25 is an elevational side view of selected elements of the machining apparatus 182 in a collapsed condition.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A machining apparatus, comprising:
a base defining a longitudinal axis;
a trolley comprising a lower section disposed on the base and an upper section disposed on the lower section;
an upright assembly removably connected to the base;
a cross-cut guide connected to the trolley; and
a carriage slidably disposed on the cross-cut guide;
wherein the trolley slides along the base parallel to the longitudinal axis, and
wherein the upper section moves along a transverse axis that is transverse to the longitudinal axis such that the upper section transitions between a retracted position and an extended position, establishing a predetermined distance between the cross-cut guide and the upright assembly when the upper section is in the extended position.

2. The machining apparatus of claim 1, wherein the base comprises:
a first base portion; and
a second base portion,
wherein the first base portion is removably connectable to the second base portion.

3. The machining apparatus of claim 1, further comprising:
a first upright base attachment slidably disposed on the base; and
a second upright base attachment slidably disposed on the base,
wherein the upright assembly removably attaches to the first and second upright base attachments.

4. The machining apparatus of claim 1, wherein the base further comprises:
a first rail; and
a second rail disposed a predetermined distance from the first rail;
wherein the first and second rails extend long the longitudinal axis of the base.

5. The machining apparatus of claim 3, wherein the upright assembly comprises:
a first support bracket connectible to the first upright base attachment;
a second support bracket connectible to the second upright base attachment; and
a plurality of uprights comprising a first upright connected to the first support bracket and a second upright connected to the second support bracket, with any remaining ones of the plurality of uprights being disposed between the first upright and the second upright.

6. The machining apparatus of claim 5, further comprising:
a ripping guide disposed between the first upright and the second upright.

7. The machining apparatus of claim 6, wherein the ripping guide is adjustable along a vertical axis that is orthogonal to the longitudinal and transverse axes.

8. The machining apparatus of claim 7, wherein the ripping guide further comprises:
a plurality of slots; and
a plurality of brackets slidably disposed in the plurality of slots.

9. The machining apparatus of claim 5, wherein the trolley slides on the base between the first upright base attachment and the second upright base attachment.

10. The machining apparatus of claim 1, wherein the cross-cut guide comprises:
a first cross-cut portion; and
a second cross-cut portion removably connected to the first cross-cut portion.

11. The machining apparatus of claim 1, wherein the cross-cut guide comprises:
a longitudinal opening extending along a length thereof;
a first surface on a first side; and
a second surface on a second side.

12. The machining apparatus of claim 11, wherein the carriage comprises:
a body disposable on the cross-cut guide, wherein the body defines an exposed surface capable of receiving a tool thereon;
a plurality of first wheels disposed on the body, wherein the plurality of first wheels engage the first surface of the cross-cut guide; and
a plurality of second wheels disposed on the body, wherein the plurality of second wheels engage the second surface of the cross-cut guide.

13. The machining apparatus of claim 1, further comprising:
a force-assist mechanism connected between the carriage and the cross-cut guide to facilitate movement of the carriage on the cross-cut guide.

14. The machining apparatus of claim 13, wherein the force-assist mechanism comprises:
a frame;
a cable reel disposed on the frame; and
a cable disposed on the cable reel,
wherein the cable includes a loose end, and
wherein the loose end connects to the carriage.

15. The machining apparatus of claim 14, wherein the cable reel comprises:
a spring that biases movement of the cable reel in one direction of rotation.

16. The machining apparatus of claim 1, further comprising:
a height adjustment mechanism connected to the base permitting adjustment of a height of the base from a ground surface.

17. The machining apparatus of claim 5, further comprising:
an upright support bar on which the plurality of uprights are slidably disposed.

18. The machining apparatus of claim 1, further comprising:
a protractor assembly disposed on the trolley to which the cross-cut guide is attached.

19. The machining apparatus of claim 18, wherein the cross-cut guide is attached to the protractor assembly to be positionable at a predetermined angle with respect to the longitudinal axis.

20. The machining apparatus of claim 1, further comprising:
a plurality of wheels attached to the base.
